(19) United States
(12) Patent Application Publication
(10) Pub. No.: US 2026/0228924 A1
(43) Pub. Date: Aug. 6, 2026

(54) SYSTEM FOR RELIABLE TRANSMISSION OF HIGH-RESOLUTION IMAGERY THROUGH A DEGRADED DATA LINK

(71) Applicant: Raytheon Company, Arlington, VA (US)

(72) Inventors: Derek C. Moore, PARADISE, TX (US); Brenna N. Peltier, Prosper, TX (US); Jose F. Sieira, MCKINNEY, TX (US); Paul J. Lewis, ALLEN, TX (US)

(21) Appl. No.: 19/383,027

(22) Filed: Nov. 7, 2025

Related U.S. Application Data
(60) Provisional application No. 63/753,759, filed on Feb. 4, 2025.

(51) Int. Cl. G06T 9/00; G01S 13/90; G06T 7/11

(52) U.S. Cl. CPC G06T 9/00; G01S 13/9021; G06T 7/11

(57) ABSTRACT

A system for reliable transmission of high-resolution imagery through a degraded data link may divide a high-resolution image into a plurality of image tiles. Each of the image tiles may be encoded with metadata including the image sequence number, the number of tiles in the image, and the tile sequence number. Protocol packets may be generated for transmission to a receiver over the data link. Each packet may include single one of the encoded tiles. A retransmit request may be received from the receiver comprising information indicating missing image tiles that were not received properly. The missing image tiles that were not properly received may be retransmitted over the data link. The number of the missing image tiles requested by the receiver for retransmission is limited to a predetermined number.

### CLAIM OF PRIORITY

This patent application claims the benefit of U.S. Provisional Patent Application No. 63/753,759, filed February 4, 2025, which is incorporated by reference herein in its entirety.

### TECHNICAL FIELD

Embodiments pertain to the transmission of images. Some embodiments relate to transmission of high-resolution sensor imagery, such as Synthetic Aperture Radar (SAR) imagery. Some embodiments relate to transmission of high-resolution sensory imagery from an aerial platform, such as an unmanned aerial vehicle (UAV), to a ground station.

### BACKGROUND

One issue with the transmission of imagery, particularly high-resolution sensor imagery from an unmanned platform to a ground station, is degradation of the data link. There are several factors that can affect data link quality between unmanned aerial vehicles and ground stations. These factors may include physical interference caused by terrain and obstacles blocking line of sight, buildings and urban structures creating multipath effects, dense foliage attenuating signals, as well as precipitation and other atmospheric conditions. These factors may include technical factors such as signal congestion in shared frequency bands, radio frequency interference from other electronic systems, limited transmitter power affecting range, antenna alignment and polarization mismatches, and signal processing delays. These factors may also include operating conditions such as aircraft attitude changes affecting antenna coverage, distance between the UAV and the ground station or satellite, flight path routing impacting signal strength, among others.

Conventional techniques to help assure data transfer, such as the Transmission Control Protocol (TCP), are generally unsuitable for high-latency degraded datalinks, as the requirement to acknowledge or retry every packet can quickly cause a degraded link to become congested.

Thus, there are needs for improved techniques for the transmission of high-resolution imagery through a degraded data link. Thus, there are also needs for improved techniques for the transmission of sensor imagery from an unmanned platform to a ground station through a degraded data link.

### BRIEF DESCRIPTION OF THE DRAWINGS

FIG. 1A and FIG. 1B illustrate a system for transmission of high-resolution radar imagery through a data link, in accordance with some embodiments.

FIG. 2 is a function block diagram of airborne platform circuitry configured for transmission of high-resolution radar imagery through a data link, in accordance with some embodiments.

FIG. 3A and FIG. 3B illustrate transmission of image tiles and retransmission of missing image tiles, in accordance with some embodiments.

FIG. 4 illustrates message sequencing for transmission of image tiles and retransmission of missing image tiles, in accordance with some embodiments.

FIG. 5 illustrates Synthetic Aperture Radar (SAR) imagery generated at a ground station in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Embodiments disclosed herein are directed to improved techniques for the transmission of high-resolution imagery through degraded data links. Some embodiments are directed to improved techniques for the transmission of sensor imagery from an unmanned platform to a ground station through a degraded data link.

In some embodiments, a system for reliable transmission of imagery through a degraded data link may divide an image into a plurality of image tiles. Each of the image tiles may be encoded with metadata including the image sequence number, the number of tiles in the image, and the tile sequence number. Protocol packets may be generated for transmission to a receiver over the data link. Each packet may include single one of the encoded tiles. A retransmit request may be received from the receiver comprising information indicating missing image tiles that were not received properly. The missing image tiles that were not properly received may be retransmitted over the data link. The number of the missing image tiles requested by the receiver for retransmission may be limited to a predetermined number. These embodiments, as well as others are described in more detail herein.

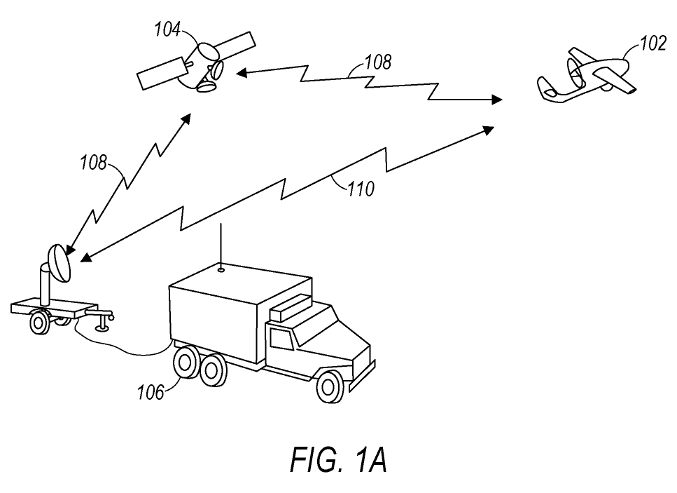

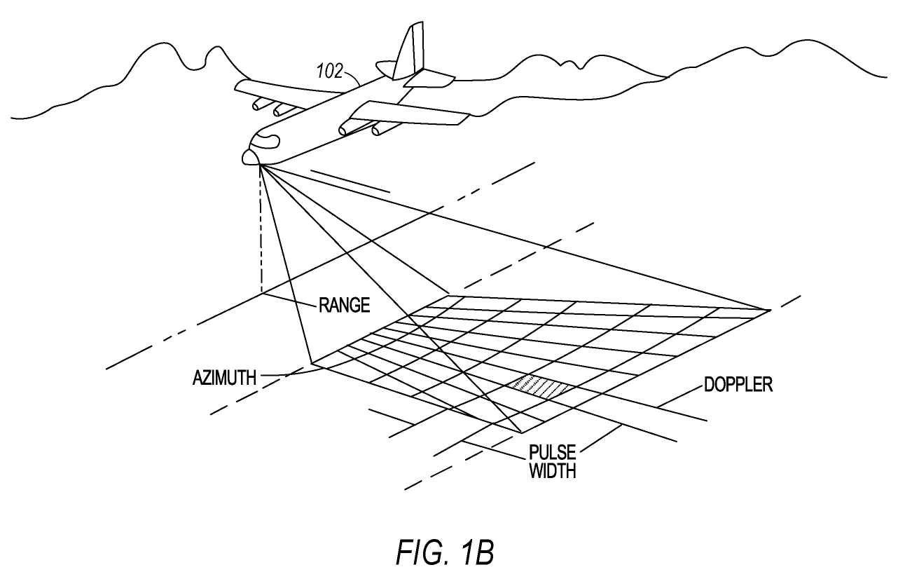

FIG. 1A and FIG. 1B illustrate a system for reliable transmission of high-resolution radar imagery through a degraded data link, in accordance with some embodiments. The system may include airborne platform 102 and ground station 106 which may communicate over data link 108 and or data link 110. Data link 108 may utilize satellite network 104. In some embodiments, the data link 108/110 may be a radio frequency (RF) link, an optical communication link or a combination thereof. At the airborne platform 102, an image may be divided into a plurality of image tiles. Each of the image tiles may be encoded with metadata including the image sequence number, the number of tiles in the image, and the tile sequence number. Protocol packets may be generated for transmission to a receiver at the ground station 106 over the data link 108. Each packet may include single one of the encoded tiles. A retransmit request may be received from the receiver comprising information indicating missing image tiles that were not received properly. The missing image tiles that were not properly received may be retransmitted over the data link 108. The number of the missing image tiles requested by the receiver for retransmission may be limited to a predetermined number. These embodiments are discussed in more detail herein.

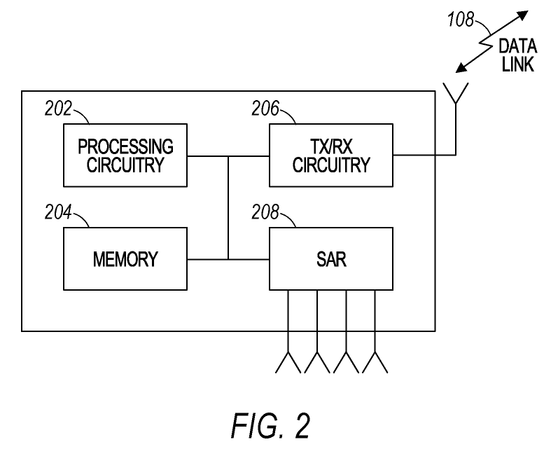

FIG. 2 is a function block diagram of airborne platform circuitry for transmission of high-resolution radar imagery through a degraded data link, in accordance with some embodiments. The airborne platform circuitry illustrated in FIG. 2 may be located on an airborne platform, such as airborne platform 102 (FIG. 1A and FIG. 1B). The airborne platform circuitry may include a synthetic aperture radar (SAR) 208 transceiver circuitry (TX/RX) 206, processing circuitry 202, memory 204. In these embodiments, the processing circuitry 202 may divide a high-resolution image generated by SAR 208 into a plurality of image tiles and encode each of the image tiles with metadata including an image sequence number, a number of tiles in the image, and a tile sequence number; and generate protocol packets for transmission by the transceiver circuitry 206 to a receiver over the data link 108. In these embodiments, each packet may include single one of the encoded tiles. In these embodiments, the processing circuitry may receive a retransmit request from the receiver comprising information indicating missing image tiles that were not received properly and may configure the transceiver circuitry to retransmit the missing image tiles that were not properly received over the data link 108. In these embodiments, the number of the missing image tiles requested by the receiver for retransmission is limited to a predetermined number. Memory 204 may be configured to store the image tiles. In some embodiments, the receiver is located at a fixed ground station, a mobile ground station, or an aerial vehicle.

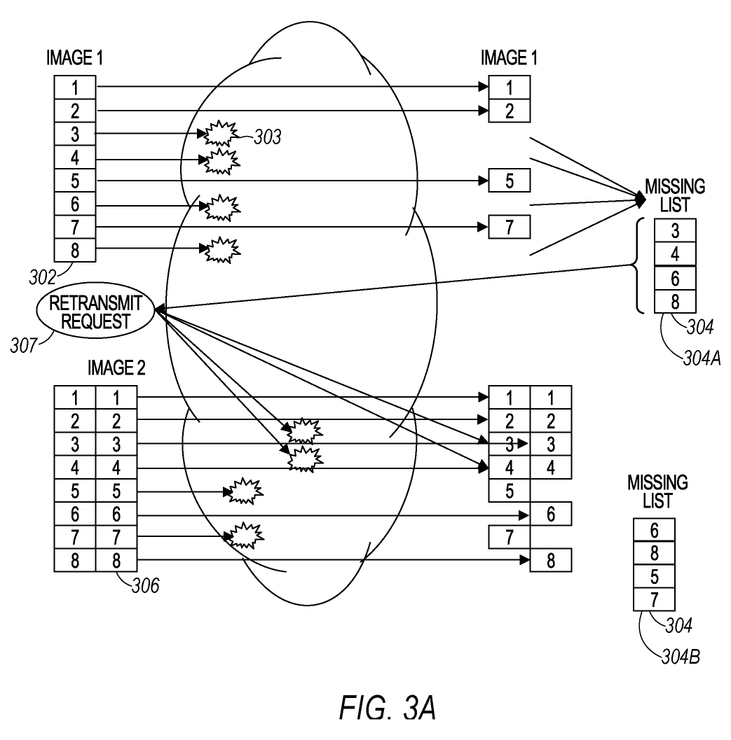

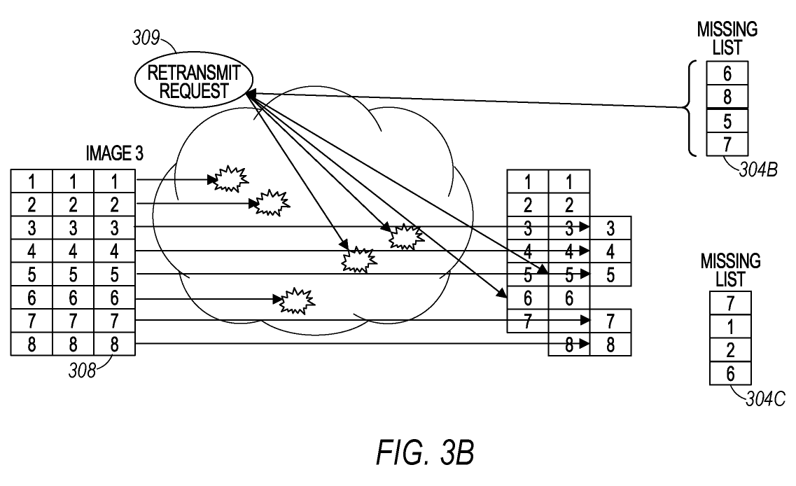

FIG. 3A and FIG. 3B illustrate transmission of image tiles and retransmission of missing image tiles, in accordance with some embodiments. FIG. 3A illustrates the transmission of image tiles 302 of a first image, image number one. FIG. 3A also illustrates the addition of missing image tiles to list 304A and a retransmit request 307 identifying the missing image tiles on list 304A (e.g., illustrated as dropped packets 303). FIG. 3A also illustrates the transmission of image tiles 306 of image number two as well as the generation of list 304B that identifies the missing image tiles of image number one and image number two. FIG. 3B illustrates the transmission of image tiles 308 of image number three as well as the generation of list 304C that identifies the missing image tiles.

As discussed above, a high-resolution image may be divided into a plurality of image tiles 302. Each of the image tiles 302 may be encoded with metadata including an image sequence number, a number of tiles in the image, and a tile sequence number. Protocol packets may be generated for transmission to a receiver over the data link 108. In these embodiments, each packet may include single one of the encoded image tiles. In these embodiments, a retransmit request 307 may be received from the receiver comprising information indicating missing image tiles that were not received properly. The missing image tiles (i.e., on list 304) that were not properly received may be retransmitted over the data link. In these embodiments, the number of the missing image tiles requested by the receiver for retransmission is limited to a predetermined number.

In some embodiments, the packets may be transmitted sequentially (i.e., one at a time, not in parallel) over the data link. In these embodiments, the retransmit request 307 received from the receiver may comprises a list 304 of the missing image tiles of one or more prior transmitted high-resolution images. The missing image tiles on the list may be identified by their image sequence number and their tile sequence number. In these embodiments, a number of missing image tiles on the list is limited to the predetermined number.

In some embodiments, the receiver may maintain the list of missing image tiles by adding missing image tiles of each subsequent high-resolution image that are not received properly to the list, and removing oldest ones of the missing image tiles from the list to limit a number of missing image tiles on the list to the predetermined number. In these embodiments, the oldest image tiles may be dropped from the list. In some embodiments, the oldest missing image tiles on the list may be determined based on earliest image number or based on timestamps. In some embodiments, the list length (M) may be determined based on available storage (e.g., buffer capacity available in memory 204) at the transmitter (e.g., airborne) side of the data link.

In some embodiments, the retransmit request 307 is received subsequent to transmission of one or more image tiles of a subsequent high-resolution image. In these embodiments, the trigger for the retransmit request 307 for the missing image tiles from image one may be the receipt of the first image tile of image two at the ground station 106. In other words, receipt of the first image tile of image two triggers the ground station to send the retransmit request 307 for the missing image tiles from image one.

In some alternate embodiments, the retransmit request 307 may be received prior to transmission of image tiles of the subsequent high-resolution image, although the scope of the embodiments is not limited in this respect. In some alternate embodiments, the processing circuitry configures the transceiver circuitry to retransmit the missing image tiles on the list prior to transmission of image tiles of a subsequent high-resolution image, although the scope of the embodiments is not limited in this respect.

In the example embodiments illustrated in FIG. 3A, image tiles (e.g., tiles 3, 4, 7 and 8) were not successfully received (e.g., illustrated as dropped packets 303). In the example embodiments illustrated in FIG. 3A, the retransmit request 307 for the missing image tiles (e.g., tiles 3, 4, 7 and 8) from image one on the list 304A may be received prior to transmission of image tiles 306 of image two, however this is not a requirement as the trigger for the retransmit request 307 for the missing image tiles from image one may be the receipt of the first image tile of image two at the ground station. Furthermore, in the example embodiments illustrated in FIG. 3B, the retransmit request 309 for the missing image tiles from images one and two on the next list (i.e., list 304B) is received prior to transmission of image tiles 308 of image three, however this is not a requirement as the trigger for the retransmit request 309 for the missing image tiles from images one and two may be the receipt of the first image tile of image three at the ground station.

In FIG. 3A and FIG. 3B, list 304B illustrates the missing image tiles after the initial transmission of the image tiles 306 of image two and the retransmission of the missing image tiles on list 304A. In this example, list 304B shows that image tiles 6 and 8 of image one are still missing after a retransmission attempt, and that image tiles 5 and 7 are missing from image two after an initial transmission attempt. Image tiles 3 and 4 from image 1 (from list 304A) have been retired (i.e., not placed on list 304B) since they have been successfully received.

In FIG. 3B, list 304C illustrates the missing image tiles after the retransmission of the missing image tiles on list 304B and the initial transmission of image tiles 308 of image three. In this example, list 304C shows that image tile 7 of image two is still missing after a retransmission attempt and that image tiles 1, 2 and 6 are now missing from image three after an initial transmission attempt. In this example, image tile 8 of image one, which had not been successfully received after a retransmission attempt, has been dropped from the list 304C to prevent the list from exceeding the predetermined number (e.g., four) in this example since it is the oldest tile that has not been successfully received.

In some embodiments, the image may be a high-resolution radar image generated by a synthetic aperture radar (SAR) 208. In these embodiments, the processing circuitry may divide the high-resolution radar image into a predetermined number of image tiles, determine a size (e.g., in KB or MB) of the image tiles based on an effective data-rate of the data link 108 and a transmission time frame. In these embodiments, the image-tile size may be determined to allow an initial transmission of the image tiles of a current high-resolution radar image before a next high-resolution radar image is generated and ready for initial transmission.

In these embodiments, the processing circuitry may also select an image compression level for compressing the image tiles of the current high-resolution radar image based on the determined image-tile size. The image tiles may be compressed in accordance with the selected image compression level before transmission over the data link.

This process may be repeated for each subsequent high-resolution radar image allowing the system to dynamically respond to changes in the effective data-rate of the data link 108, although the scope of the embodiments are limited in this respect.

In some embodiments, a smaller image-tile size (i.e., higher compression) may be used in response to lower effective data-rates and a larger image-tile size (i.e., lower compression) may be used in response to higher effective data-rates. In these embodiments, the image-tile size of the image tiles may be reduced in response to a lower effective data-rate. In these embodiments, the processing circuitry may dynamically adjust the image-tile size/compression level in response to changing effective data-rates. In these embodiments, the image-tile size/compression level may be selected so that a maximum packet size (e.g., 64 kB) is not exceeded.

In some of these embodiments, the number of tiles of the high-resolution radar image may remain fixed and the image-tile size/compression level is selected based on the effective data-rate. In these embodiments, the high-resolution radar image generated by the SAR 208 may have a predetermined size (e.g., 2 to 20 MB uncompressed).

In some embodiments, the data link 108 may be a lossy data link affected (e.g., degraded) by changing environmental conditions (e.g., moisture, solar flares). In these embodiments, the processing circuitry may determine, in real-time, a current data-rate of the data link, determine, based on the current data-rate, the effective data-rate for transmission of high-resolution radar imagery, and determine the image-tile size based on the effective data-rate. In these embodiments, only a portion of a total data-rate of the data link may be allocated for the transmission of high-resolution radar imagery. In these embodiments, the data link 108 may be used for other purposes as well including control signalling (e.g., for controlling an airborne platform 102). The control signalling may be prioritized over the transmission of radar imagery.

In some embodiments, the SAR 208 may generate a plurality of sequential high-resolution radar images. Each of the sequential high-resolution radar images having a different image sequence number. In these embodiments, each subsequent image may be adjacent to a prior-generated image and is associated with an image sequence number. In some embodiments, each subsequent image may be substantially non-overlapping with the prior-generated image, although this is not a requirement as the images may overlap slightly, however due to unpredictable flight dynamics. In some embodiments, successive images may be displayed on an operation station as well as saved for later analysis.

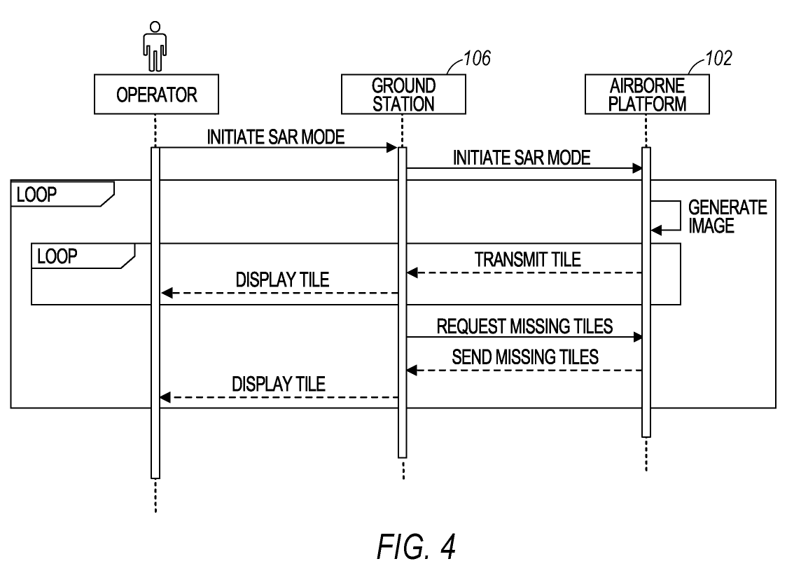

FIG. 4 illustrates message sequencing for transmission of image tiles and retransmission of missing image tiles, in accordance with some embodiments. As illustrated in FIG. 4, an operator may initiate SAR mode and instruct an airborne platform 102 with a SAR (i.e., an airborne radar) may generate a high-resolution radar image. The image may be divided into a plurality of image tiles and the tiles may be individually transmitted in packets to the ground station 106. The ground station 106 may display the tiles for the operator and request any missing tiles from the airborne radar. The requested missing tiles may be retransmitted to the ground station and displayed. Missing tiles may appear as holes in the generated image.

While FIG. 1A and FIG. 1B illustrate examples of a ground-based station where the receiver may be located, it should be appreciated that a variety of other operational scenarios are possible for receiver implementation. For example, in some other embodiments, the receiver can be located at sea-based command center or an aerial vehicle (e.g., either manned or unmanned). Additionally, it should be appreciated that the ground station 106 can be implemented both as a fixed (non-mobile) station and a portable/mobile ground station.

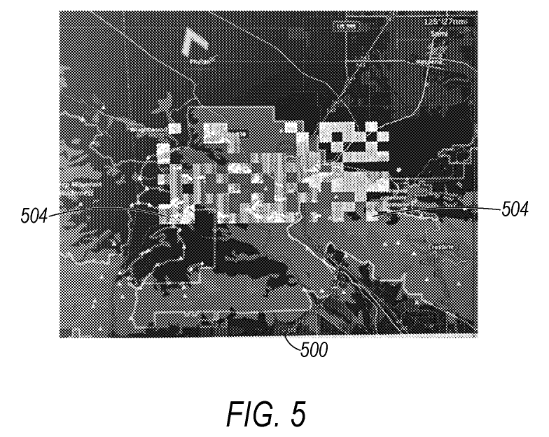

FIG. 5 illustrates Synthetic Aperture Radar (SAR) imagery generated at a ground station in accordance with some embodiments. In these embodiments, at the ground station 106 (FIG. 1), the high-resolution radar image 500 (FIG. 5) is generated from the received packets without the missing image tiles. The missing image tiles may be generated (i.e., may appear) as holes 502 (FIG. 5) (i.e., blank image tiles where the missing image tiles should be). In these embodiments, the ground station may fill in the holes 502 upon successfully retransmission of any of the missing image tiles. In these embodiments, image tiles from a particular image that are dropped/removed from the list may remain as holes in that image (i.e., they are never filled in).

Referring to FIG. 1 and FIG. 2, in some embodiments, the transceiver circuitry 206, the processing circuitry 202, and the memory 204 are configured to be located on an airborne platform 102 (e.g., an unmanned airborne vehicle (UAV), drone or aircraft) (see FIG. 1). In these embodiments, the data link 108 may comprise a Ku-band SATCOM data link, the receiver may be located at the ground station 106, and the data link 108 may include an uplink to a satellite network 104 and a downlink from the satellite network to the ground station 106, although the scope of the embodiments is not limited in this respect.

In some embodiments, the data link may be a direct data link 110 between the airborne platform 102 and the ground station 106, although the scope of the embodiments is not limited in this respect. In some of these embodiments, detailed SAR images (e.g., of the Earth's surface) may be captured by a UAV or small drone with a SAR and may then be transmitted to a ground station through a satellite network 104. In some embodiments, instead or in addition to satellite network 104, airborne platform 102 may send data to another aircraft which may be used by the other aircraft or routed to the ground station.

Some embodiments are directed to an unmanned aerial vehicle (UAV) 102 comprising a synthetic aperture radar (SAR) 208 to generate a high-resolution image. The UAV may include processing circuitry 202 to divide the high-resolution image into a plurality of image tiles 302 and encode each of the image tiles with metadata including an image sequence number, a number of tiles in the image, and a tile sequence number. The processing circuitry may generate packets for transmission by transceiver circuitry 206 to a receiver over a data link 108. In these embodiments, each packet includes a single one of the encoded tile. In these embodiments, the transceiver circuitry 206 may receive a retransmit request 307 comprising information indicating missing image tiles that were not received properly. The transceiver circuitry may be configured to retransmit the missing image tiles over the data link 108. In these embodiments, a number of the missing image tiles requested by the receiver for retransmission is limited to a predetermined number.

Some embodiments are directed to a receiver system for reliable reception of high-resolution imagery and targeting data through a data link 108. The receiver system may be located at a ground station 106 (or a sea-based command station or an aerial vehicle) and may comprise processing circuitry and memory. In these embodiments, the processing circuitry may decode packets received over a data link 108. Each packet may comprise a single encoded image tile of a high-resolution image and each of the image tiles may be encoded with metadata including an image sequence number, a number of tiles in the image, and a tile sequence number. The receiver system may generate a retransmit request comprising a list of missing image tiles that were not received properly. The number of the missing image tiles requested for retransmission may be limited to a predetermined number.

In these embodiments, the list comprises the missing image tiles of one or more prior transmitted high-resolution images, the missing image tiles on the list identified by their image sequence number and their tile sequence number. In these embodiments, image-generation circuitry at the ground station 106 may maintain the list of missing image tiles by adding missing image tiles of each subsequent high-resolution image that are not received properly to the list. The processing circuitry may remove oldest ones of the missing image tiles from the list to limit a number of missing image tiles on the list to the predetermined number. In these embodiments, the retransmit request 307 may be transmitted subsequent to receipt of one or more image tiles of a subsequent high-resolution image. In these embodiments, the retransmit request 307 may be triggered by receipt of an initial image tile of the subsequent high-resolution image.

In some embodiments, the high-resolution image may be a high-resolution radar image may be generated by a synthetic aperture radar (SAR) 208 on an airborne platform 102. In these embodiments, an image-tile size may be determined based on an effective data-rate of the data link 108 and a transmission time frame. The image-tile size may be determined to allow an initial transmission of the image tiles of a current high-resolution radar image before a next high-resolution radar image is generate. In these embodiments, an image compression level for compressing the image tiles of the current high-resolution radar image is selected based on the image-tile size.

In some of these embodiments, image-generation circuitry at the ground station may generate a high-resolution radar image 500 (FIG. 5) from the received packets without the missing image tiles. The missing image tiles may appear as holes 502 (FIG. 5). In these embodiments, the processing circuitry (of the ground station 106) may fill in the holes 502 upon successfully retransmission of missing image tiles.

Some embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system for transmission of imagery through a data link, the system comprising: transceiver circuitry, processing circuitry, and memory,
wherein the processing circuitry is configured to:
divide an image into a plurality of image tiles;
encode each of the image tiles with metadata including an image sequence number, a number of tiles in the image, and a tile sequence number;
generate packets for transmission by the transceiver circuitry to a receiver over the data link, wherein each packet includes a single one of the encoded tiles;
receive a retransmit request from the receiver, the retransmit request comprising information indicating missing image tiles that were not received properly;
retransmit the missing image tiles that were not properly received over the data link,
wherein a number of the missing image tiles requested by the receiver for retransmission is limited to a predetermined number.

2. The system of claim 1, wherein the packets are transmitted sequentially over the data link;
wherein the retransmit request received from the receiver comprises a list of the missing image tiles of one or more prior transmitted images, the missing image tiles on the list identified by their image sequence number and their tile sequence number, and
wherein a number of missing image tiles on the list is limited to the predetermined number.

3. The system of claim 2, wherein the receiver is configured maintain the list of missing image tiles by:
adding missing image tiles of each subsequent image that are not received properly to the list; and
removing oldest ones of the missing image tiles from the list to limit a number of missing image tiles on the list to the predetermined number.

4. The system of claim 2, wherein the retransmit request is received subsequent to transmission of one or more image tiles of a subsequent image.

5. The system of claim 2, wherein the image is a high-resolution radar image generated by a synthetic aperture radar (SAR), and wherein the processing circuitry is configured to:
divide the high-resolution radar image into a predetermined number of image tiles;
determine an image-tile size based on an effective data-rate of the data link and a transmission time frame, the image-tile size determined to allow an initial transmission of the image tiles of a current high-resolution radar image before a next high-resolution radar image is generated;
select an image compression level for compressing the image tiles of the current high-resolution radar image based on the image-tile size; and
compress the image tiles in accordance with the image compression level before transmission over the data link.

6. The system of claim 5, wherein a smaller image-tile size is used in response to lower effective data-rates, and a larger image-tile size is used in response to higher effective data-rates.

7. The system of claim 6, wherein the data link is a lossy data link affected by changing environmental conditions, and wherein the processing circuitry is configured to:
determine, in real-time, a current data-rate of the data link;
determine, based on the current data-rate, the effective data-rate for transmission of high-resolution radar imagery; and
determine the image-tile size based on the effective data-rate, wherein a portion of a total data-rate of the data link is allocated for the transmission of high-resolution radar imagery.

8. The system of claim 2, wherein the image is one of a plurality of sequential high-resolution radar images generated by a synthetic aperture radar (SAR), each of the sequential high-resolution radar images having a different image sequence number, and
wherein each subsequent image is adjacent to a prior-generated image and is associated with an image sequence number.

9. The system of claim 8, wherein at the receiver, the high-resolution radar image is generated from the received packets without the missing image tiles, the missing image tiles generated as holes, and wherein the receiver is configured to fill in the holes upon successful retransmission of corresponding missing image tiles.

10. The system of claim 1, wherein the transceiver circuitry, the processing circuitry, and the memory are located on an airborne platform,
wherein the data link comprises a Ku-band SATCOM data link,
wherein the receiver is located at a ground station, and
wherein the data link includes an uplink to a satellite network and a downlink from the satellite network to the ground station.

11. An unmanned aerial vehicle (UAV) configured for transmission of imagery, the UAV comprising:
a synthetic aperture radar (SAR) to generate an image; and
processing circuitry to:
divide the image into a plurality of image tiles;
encode each of the image tiles with metadata including an image sequence number, a number of tiles in the image, and a tile sequence number;
generate packets for transmission by transceiver circuitry to a receiver over a data link, wherein each packet includes a single one of the encoded tiles; and
decode a retransmit request comprising information indicating missing image tiles that were not received properly,
wherein the transceiver circuitry is configured to retransmit the missing image tiles over the data link, and
wherein a number of the missing image tiles requested by the receiver for retransmission is limited to a predetermined number.

12. The UAV of claim 11, wherein the packets are transmitted sequentially over the data link;
wherein the retransmit request received from the receiver comprises a list of the missing image tiles of one or more prior transmitted images, the missing image tiles on the list identified by their image sequence number and their tile sequence number, and
wherein a number of missing image tiles on the list is limited to the predetermined number.

13. The UAV of claim 12, wherein the receiver is configured maintain the list of missing image tiles by:
adding missing image tiles of each subsequent image that are not received properly to the list; and
removing oldest ones of the missing image tiles from the list to limit a number of missing image tiles on the list to the predetermined number.

14. The UAV of claim 12, wherein the retransmit request requesting retransmission of missing images tiles from one or more prior images is received after transmission of an image tile of a next image in a sequence of images.

15. The UAV of claim 12, wherein the image is a high-resolution radar image generated by the SAR, and wherein the processing circuitry is configured to:
divide the high-resolution radar image into a predetermined number of image tiles;
determine an image-tile size based on an effective data-rate of the data link and a transmission period, the image-tile size determined to allow an initial transmission of the image tiles of a current high-resolution radar image before a next high-resolution radar image is generated;
select an image compression level for compressing the image tiles of the current high-resolution radar image based on the image-tile size; and
compress the image tiles in accordance with the image compression level before transmission over the data link.

16. A receiver system for reliable reception of imagery through a data link, the system comprising: processing circuitry; and memory,
wherein the processing circuitry is configured to:
decode packets received over the data link, each packet comprising a single encoded image tile of an image, each of the image tiles encoded with metadata including an image sequence number, a number of tiles in the image, and a tile sequence number;
generate a retransmit request comprising a list of missing image tiles that were not received properly; and
limit a number of the missing image tiles requested for retransmission to a predetermined number.

17. The receiver system of claim 16, wherein the list comprises the missing image tiles of one or more images previously transmitted to the receiver system over the data link, the missing image tiles on the list identified by their image sequence number and their tile sequence number,
wherein the processing circuitry is configured to maintain the list of missing image tiles by:
adding missing image tiles of each subsequent image that are not received properly to the list; and
removing oldest ones of the missing image tiles from the list to limit a number of missing image tiles on the list to the predetermined number.

18. The receiver system of claim 17, wherein the retransmit request requesting retransmission of missing images tiles from one or more prior images is triggered by receipt of an image tile of a next image in a sequence of images.

19. The receiver system of claim 18, wherein the image is a high-resolution radar image generated by a synthetic aperture radar (SAR) on an airborne platform,
wherein an image-tile size is determined based on an effective data-rate of the data link and a transmission time frame, the image-tile size determined to allow an initial transmission of the image tiles of a current high-resolution radar image before a next high-resolution radar image is generate, and
wherein an image compression level for compressing the image tiles of the current high-resolution radar image is selected based on the image-tile size.

20. The receiver system of claim 17, further comprising image-generation circuitry to locally generate a high-resolution radar image from the received packets without the missing image tiles, the missing image tiles generated as blank image tiles,
wherein image-generation circuitry is configured to fill in the blank image tiles upon successful reception of the missing image tiles; and
wherein the receiver is located at one of a fixed ground station, a mobile ground station, and an aerial vehicle.
